(19) United States
(12) Patent Application Publication
(10) Pub. No.: US 2017/0098389 A1
(43) Pub. Date: Apr. 6, 2017

(54) Method and system for children learning languages

(71) Applicant: Perfect Union Co., Ltd., Taipei (TW)

(72) Inventor: Kuo-Tai Clive Liu, Los Altos Hills, CA (US)

(21) Appl. No.: 14/875,819

(22) Filed: Oct. 6, 2015

(51) Int. Cl. G09B 19/06; G09B 11/00; G09B 5/06

(52) U.S. Cl. CPC G09B 19/06; G09B 5/06; G09B 11/00

(57) ABSTRACT

Method and system for children learning one or more languages is presented. In one embodiment, a method and system comprises looking at pictures, looking at words in one or more forms, looking at texts depicting one or more relations between words, and listening to audios of words, texts to develop the reading skills in a language, in consistent with children's cognitive developments. According to another embodiment, a method and system comprises looking at pictures, reading words in one or more forms of a language, looking at the handwriting form of the word, moving a pointing device or finger following the strokes of the handwriting form, and listening to the audios of words, texts to develop the reading and writing skills in one or more languages.

### BACKGROUND OF THE INVENTION

### Technical Field

This invention relates to method and system for children learning one or more languages, and in particular, relates to method and system for children to look at pictures, to read words in one or more formats, to listen to the audios of words, texts, and to develop the reading and writing skills, in consistent with children's cognitive developments. This invention also relates to providing the invented method and system, for improving language literacy through learning knowledge depicted by pictures, words, texts, audios using mobile computing device featuring a suitable user interface.

### Description of Related Art

The human brain of a child is wired to learn languages. It is the child's early experiences that modify the brain, influencing it to be able to learn one language as easily as another. Starting at around age two, young children could develop perceptions for various color pictures, and draw lines and circles with hands. They may also begin to logically connect objects such as alphabets, characters and words with each other. Evidence from behavioral and neuroscience has documented that proper sensory or linguistic input during this time puts the child at an advantage in learning to read when schooling begins.

Effective communication in any language depends on mastery of a relatively limited number of words. A child's vocabulary usually may include about 50 words to start, 100-200 words or more words could be developed, so a child begins to put two, then three and more words together into short sentences. Once this core vocabulary is mastered and used consistently, it provides a framework for accelerated language learning. Hence, this invention relates to method and system for children learning the core vocabulary in one or more languages simultaneously, so children can master the read and write in one or more languages with the least amount of time to become bilingual in early ages of their lives.

One example of providing children learning a language is described in U.S. Pat. No. 6,632,094B1 (Falcon et al.). This computer-implemented technique provides early readers a method to improve reading proficiency by highlighting the words displayed during the audio narration, and a phonetic pronunciation with synchronized highlighting of the phonemes is also available. In U.S. Pat. No. 6,884,076 (Clark et al.) described a system method which playbacks visuals stored on an audiovisual storage in conjunction with printed flash cards for young children to learn reading. In U.S. Pat. No. 6,517,351 (Spector) described a virtual learning system environment that provides for progressive education of children, at their own pace, through enhancement in spelling, reading comprehension and physical skills, including the use of a microphone, video camera, and means for effecting a computer generated response. In U.S. Pat. No. 7,563,099 (Iftikhar) described an apparatus and method for teaching language to young children that comprises a multi-media medium for displaying a set of visual images and corresponding audio in the language.

One example of providing a foreign language teaching aid is described in U.S. Pat. No. 5,486,111 (Watkins). This system provides a user to learn a foreign language by reading words, phrases and sentences in the primary language; then read the word-for-word translation in the foreign (secondary) language, then followed by reading in the foreign language according to proper syntax and grammar rules of the foreign language. In U.S. Pat. No. 7,257,366 (Maldonade et al.), both a first and a second language are presented in audiovisual and printed format, such as books, toys, to present consistent images to reinforce the bilingual learning for young children.

Unlike languages in the western world, the Chinese language is made up literally of words, of which each word has just one syllable and represented by its own unique character picture. For example, U.S. Pat. No. 7,689,407 (Yang et al.) relates to a method of learning a second language through the guidance of pictures that enables users to learn multiple languages through computers. U.S. Pat. No. 8,142,195 (Guo) relates to a system of learning materials that facilitated teaching Chinese characters in progressive stages independently of the fluency of a teacher. U.S. Pat. No. 7,848,919 (Yang et al.) relates to a method of editing communication sheets allowing users to insert pictures, expressions and vocabularies to assist the learning of Chinese. Learning Chinese as a native language presents some serious challenges for young children, especially when the child is borne in the western world.

With the advancement of computing devices offering images and voice processing environment, this invention takes advantages of a mobile computing environment for displaying pictures and playing audios of words, texts, allowing children to learn the concepts of words, texts non-linearly, and becoming part of their knowledge, in consistent with children's cognitive developments.

This invention also includes the process of applying the unique property of Chinese words as pictographs, during learning multiple languages, by offering the invented method and system in relating Chinese character pictures to words in other alphabetical languages.

### SUMMARY OF THE INVENTION

The summary of the invention is provided to introduce concepts of learning words in multiple languages that are further described below in the Description of the Preferred Embodiments. This summary is not intended to identify key features or essential features of the claimed subject matter, nor is it intended to be used as an aid in determining the scope of the claimed subject matter.

Embodiments of the present invention relate to allowing children to learn multiple languages easily and effectively by looking at the pictures (static or motion), listening to the syllables and tones of characters, words and texts; reading the characters, words and texts in the printing and handwriting forms, and writing the alphabets, characters, words and texts to learn the language, in consistent with children's cognitive developments.

One aspect of the present invention is offering a language learning process, allowing a child to look at a picture representing a word; read the 1^{st} word and its related 2^{nd} word in a printing form of a language; look at the 2^{nd} picture representing the 2^{nd} word; and listen to the audios of words, texts depicting the relation of the words; then, to read the 1^{st} word and the related 2^{nd} word in another form of the language, and listen to the audios of words, texts depicting the relation of the words.

A second aspect of the present invention is offering a language learning process, allowing a child to learn several descriptions of a word by learning different 2^{nd} words with pictures, texts depicting the same or different relations repeatedly. The process enables a child to look at the 1^{st} picture and read the 1^{st} word with one or more 2^{nd} words in a language; to listen to the audios of words and texts depicting one or more relations of the 1^{st} word and the 2^{nd} words; to read the 1^{st} word and the same or different 2^{nd} word in the same or different form in the language, and to listen to the audios of words and texts depicting relations of the words.

A third aspect of the present invention is offering a language learning process, allowing a child to learn the writing of a word by looking at a picture representing a word, reading the character, word in one or more printing forms of the language; listening to the audio of the word, looking at the path of one or more strokes of the character, word in the handwriting form, then moving a pointing device or finger following the path in writing the character, word, and listening to the audio of the character, word.

A fourth aspect of the present invention is offering a multilingual learning process for alphabetical languages, e.g. English, Spanish, as well as a non-alphabetical language, Chinese. The process enables a child to look at a picture representing a word, read the word in the 1st language, read the word, as a translation in the 2^{nd} language; look at a picture or a Chinese pictograph depicting the word in the 2^{nd} language, and listen to the audios of the words defined in each language respectively. Then, the process repeats one or more related words in the 1^{st} language, allowing a child to look at pictures representing the related words, and read one or more translations in the 2^{nd} language, look at a picture or a Chinese pictograph depicting the translated word in the 2^{nd} language; listen to the audios of the words, texts depicting relations, in each language respectively; and add another 3^{rd} or more languages for leaning by repeating the above process.

The present invention changes how children could develop an intuitive and rich learning experience to read and write multiple languages, in consistent with their cognitive developments. The present invention also provides for multi-lingual literacy development through learning knowledge depicted by pictures, words, texts, audios in the language of interest, using a mobile computing device featuring a suitable user interface. The foregoing and many other aspects of the present invention will no doubt become obvious to those of ordinary skill in the art after read the following Description of the Preferred Embodiments that are illustrated in various figures.

### DESCRIPTION OF THE DRAWINGS

FIG. 1 Flow diagram showing a method for children learning a language with words and their relations;

FIG. 2 Flow diagram showing a method for children learning to read and write, while listening to the audio of the word;

FIG. 3 Flow diagram showing a method for children learning to read and write multiple languages;

FIG. 4 Simplified block diagram of an exemplary computer system suitable for use in implementing one or more embodiments of the present invention;

FIG. 5 Various computer form factors that may be used in accordance with embodiments of the present invention;

FIG. 6 Exemplary multi-language character, word and word-relation dictionary;

FIG. 7 Suitable layouts for learning to read and write in multiple languages with pictures, words in different forms.

### DESCRIPTION OF THE PREFERRED EMBODIMENTS

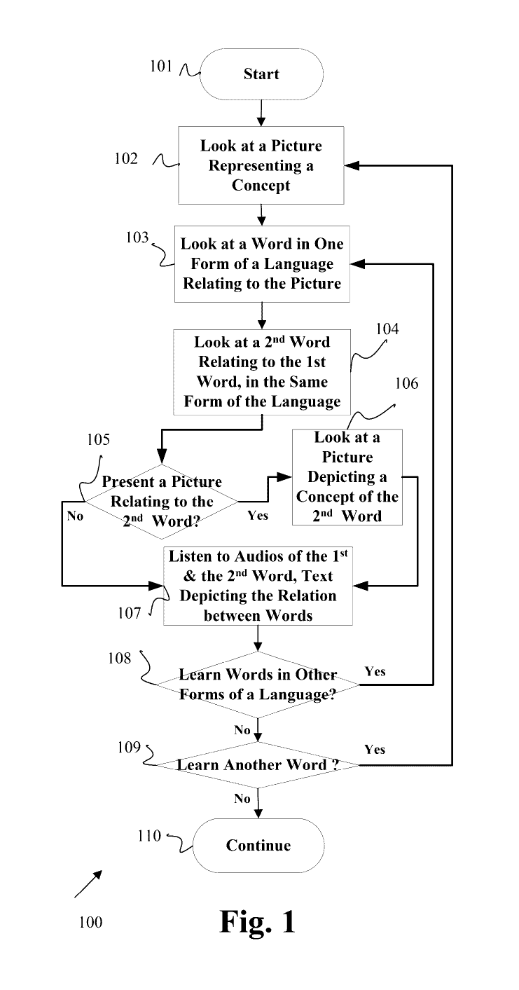

A preferred embodiment of the present invention for learning a language with words and relations between them could begin with looking at a picture, looking at a word in one form, looking at a 2^{nd} word relating to the 1^{st} word in the same form, and listening to the audios of the words and texts depicting the relations, as described in FIG. 1, indicated by general reference 100. The process 100 initiates at a “start” terminal 101 after one or more pictures, words, relations, texts and audios are made available. Initially, as shown in block 102, the software displays a picture, plays an audio of a word representing a concept presented by the picture. Next, in the block 103, the software displays a word in one form of a language relating to the picture. In block 104, the software displays a 2nd word relating to the 1st word, in the same form of the language. In block 105, each time the software is set to show a picture relating to the 2^{nd} word; the software displays a picture depicting a concept of the 2^{nd} word in block 106. Or, the software plays audios of the 1st & the 2nd word, and texts depicting the relations between words in block 107. In block 108, if the software is set to display the word in a different form, the process repeats at block 103 for learning the word in another form. In block 109, if the software is set to learn another word, the process repeats at block 102 for children to look at a picture then continues to the next step 104. Otherwise, the process 100 continues at the step 110.

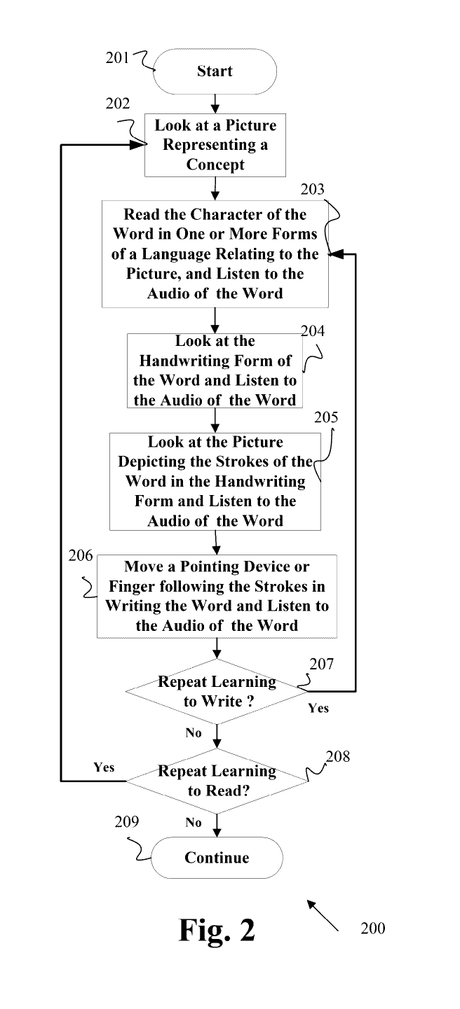

A preferred embodiment of the present invention for learning the read and write of a language could begin with looking at a picture, reading the character of the word, looking at the word in handwriting form, looking at a picture depicting the strokes of the handwriting, moving a pointing device or finger following the strokes and listening to the audio of the word as described in FIG. 2, indicated by general reference 200. The process 200 initiates at a “start” terminal 201 after pictures, words, handwriting form, picture of the strokes, and audios are made available. As shown in block 202, initially to look at a picture representing a concept. Next, in the block 203, to read the character of the word in one or more forms of a language relating to the picture, and listen to the audio of the word. In block 204, to look at the handwriting form and listen to the audio of the word. In block 205, to look at the picture depicting the strokes of the word in the handwriting form and listen to the audio of the word. In block 206, to move a pointing device or finger following the strokes in writing the word and listen to the audio of the word. In block 207, if the software is set to repeat learning to write the word, the process repeats at block 203. In block 208, if the software is set to repeat learning to read another word, the process repeats at block 202 by looking at a picture. The process 200 continues at the step 209.

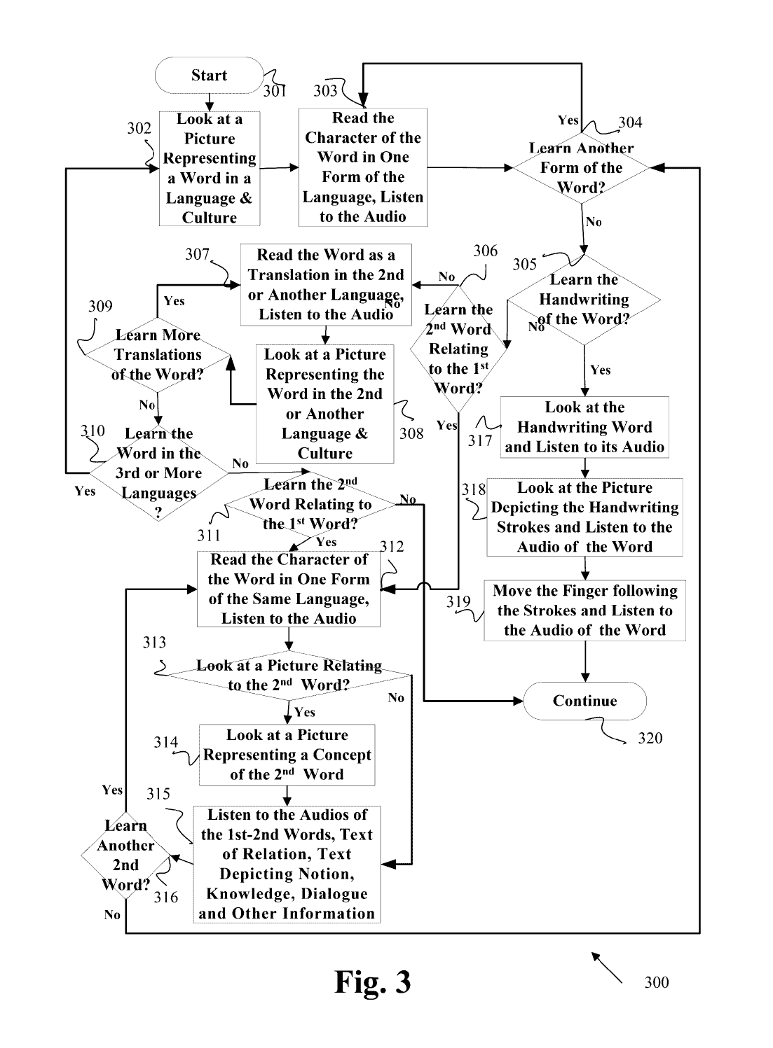

A preferred embodiment of the present invention for learning the reading and writing multiple languages could be described in FIG. 3, indicated by general reference 300. The process 300 initiates at a “start” terminal 301. Initially, as shown in block 302, to look at a picture representing a word in a language & culture. Next, in the block 303, to read the character of the word in one form of the language, and to listen to the audio. In block 304, if learning another form of the word, the process repeats at block 303. Or, in block 305, if learning the handwriting form of the word, the process continues at block 317, otherwise the process continues at block 306. In block 306, if learning the 2nd word relating to the 1st word, then the process continues at block 312, otherwise the process continues at block 307. In block 307, to read the word as a translation in the 2nd or another language, and listening to the audio. In block 308, to look at a picture representing the word in the 2nd or another language & culture. In block 309, if learning more translations of the word, the process repeats at block 307, otherwise, in block 310, if learning the word in the 3^{rd} or more languages, the process repeats at block 302, otherwise the process continues at block 311. In block 311, if learning the 2nd word relating to the 1st word, the process continues at block 312, otherwise the process continues at the step 320. In block 312, to read the character of the word in one form of the same language, and listening to the audio. In block 313, if looking at a picture relating to the 2^{nd} word, the process continues at block 314, otherwise, the process continues at block 315. In block 314, to look at a picture representing a concept of the 2nd word. In block 315, to listen to the audios of the 1st-2nd words, texts of relations, texts depicting notions, knowledges, dialogues and other information. In block 316, if learning another 2nd word, the process repeats at block 312, otherwise, the process repeats at block 304. The process 300 continues at the step 320.

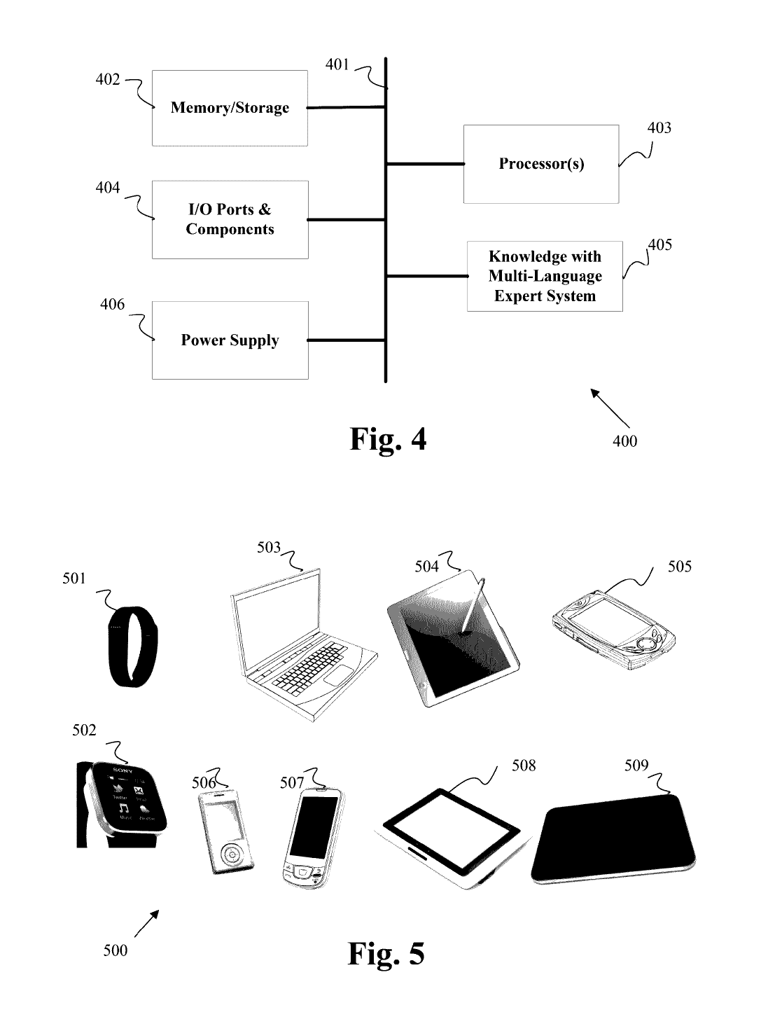

An exemplary operating environment for displaying, reading, writing, interfacing with characters and words in multiple languages could be defined as in FIG. 4. The computing device 400 includes a bus 401 that directly or indirectly couples memory/storage 402, one or more processors 403, one or more I/O ports and components 404, one or more knowledge base and multi-language expert system 405, including pictures, characters, words, relations, texts, audios, and an illustrative power supply 406.

Various computer form factors that may be used in accordance with embodiments of the present invention could be illustrated in Fig.5, including wearable devices 501, smart watches 502, notebook computers 503, tablet computers 504, personal digital assistant 505, media players 506, mobile telephones 507, electronic book/dictionary 508, pad computers 509, and the like. Additionally, the computer may be a combination of these types, for example, a device that is a combination of a personal digital assistant, media player, and mobile telephone.

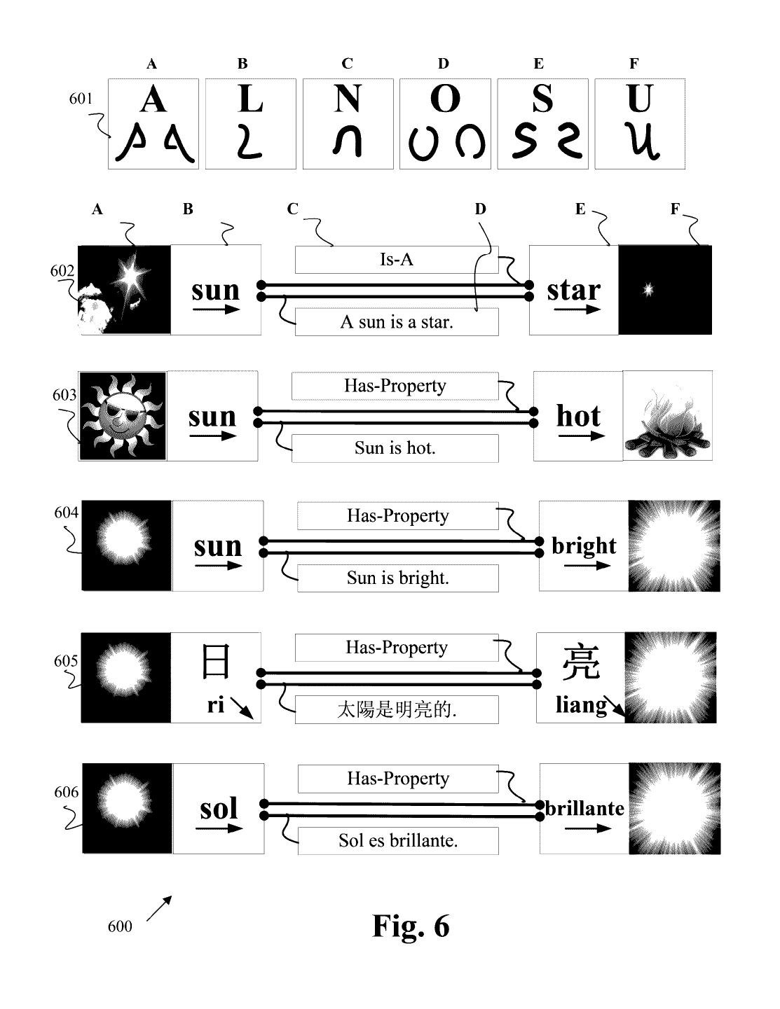

An exemplary multi-language character, word, word-relation and text dictionary could be defined as in FIG. 6. Template 600 can include a plurality of indications 601 A-F, 602 A-F, 603 A-F, 604 A-F, 605 A-F, 606 A-F. Indications 601 A-F can include alphabetical characters and corresponding one or more handwriting forms such as A, L, N, O, S and U. Indications 602 A-F can include pictures depicting SUN and STAR, words printed in “sun” and “star”, relation “is-a” between the words sun and star, and text “A sun is a star”. Indications 603 A-F can include pictures depicting SUN and HOT, words printed in “sun” and “hot”, relation “has-property” between the words sun and hot, and text “Sun is hot”. Indications 604 A-F can include pictures depicting SUN and BRIGHT, words printed in “sun” and “bright”, relation “has-property” between the words sun and bright, and text “Sun is bright”. Indications 605 A-F can include pictures depicting SUN and BRIGHT, words printed in Chinese as “ [symbol] ” and “ [symbol] ”, relation “has-property” between the Chinese words “ [symbol] ” and “ [symbol] ”, and text “ [symbol] ” in Chinese. Indications 606 A-F can include pictures depicting SUN and BRIGHT, words printed in Spanish as “sol” and “brillante”, relation “has-property” between the words “sol” and “brillante”, and text “sol es brillante” in Spanish.

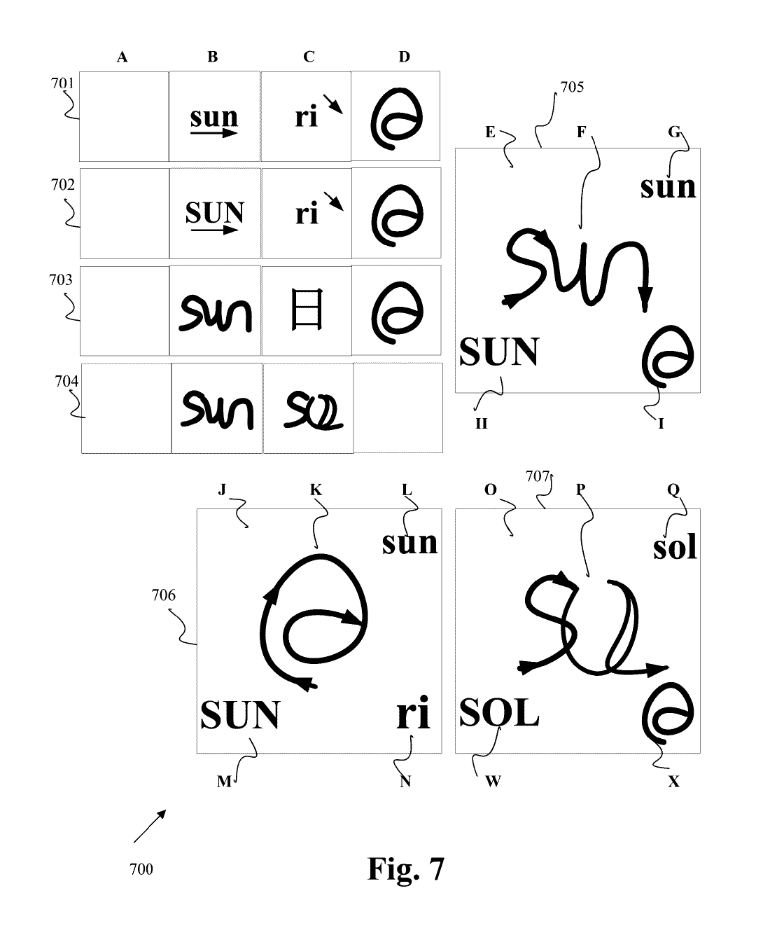

Suitable layouts for learning to read multiple languages with pictures, words in different forms, including to learn the handwriting forms in one or more languages, are defined in FIG. 7. Template 700 can include a plurality of indications 701 A-D, 702 A-D, 703 A-D and 704 A-D. Indications 701 A-D can include a picture depicting SUN, words printed in English as “sun” and in Chinese as “ri”, and Chinese word “ [symbol] ” in handwriting form. Indications 702 A-D can include a picture depicting SUN, words printed in English capital letters “SUN” and Chinese “ri”, and Chinese word “ [symbol] ” in handwriting form. Indications 703 A-D can include a picture depicting SUN, an English word “sun” in handwriting form, and Chinese word “ [symbol] ” in printing form and handwriting form. Indications 704 A-D can include a picture depicting SUN, an English word “sun” in handwriting form, a Spanish word “sol” in handwriting form, another picture depicting SOL in Spanish. Indications 705 EFGHI can include a picture depicting SUN, an English word “sun” in handwriting form for moving a pointing device or finger writing the English word, words printed in English small and capital letters “SUN”, and Chinese word “ [symbol] ” in handwriting form. Indications 706 JKLMN can include a picture depicting SUN, a Chinese word “ [symbol] ” in handwriting form for moving a pointing device or finger writing the Chinese word, words printed English small and capital letters “SUN”, and Chinese word “ [symbol] ” in alphabetical form. Indications 707 OPQWX can include a picture depicting SUN, a Spanish word “sol” in handwriting form for moving a pointing device or finger writing the Spanish word, words printed in Spanish small and capital letters “SOL”, and Chinese word “ [symbol] ” in handwriting form.

One skilled in the art will understand that the invention provides a natural and non-linear method and system for children to look at pictures, to read words in one or more forms, in one or more languages, to listen to the audios of words, texts and to develop the reading and writing skills in one or more languages, in consistent with children's cognitive developments. This invention also takes the unique nature of the Chinese pictographs in the language learning process to improving the multi-lingual literacy development through learning knowledge defined by the words, texts in the language of interest, using mobile computing devices featuring a suitable user interface.

From the foregoing, it will be appreciated that the invention has (without limitation) the following advantages:
1) The invention provides a multi-sensory method in learning reading and writing, in an order consistent with children's cognitive developments through intuitive interactions with a computing device featuring a suitable interface.
2) The invention provides an effective self-learning method for children to develop perceptions for color pictures, and logically connect pictures and symbols such as characters, words, texts with each other.
3) The invention provides a multilingual learning environment for children to learn languages in their native tones. The child who is surrounded by languages, say English and Chinese provided by the invention, will begin the journey towards learning both languages.
4) The invention provides method and system for children to learn the core vocabularies in two or more languages simultaneously, for accelerating comprehension in early age of literacy development.
5) The invention provides an advantageous method for children born in the western world to learn Chinese through English and/or other native languages; and for children born in the eastern world, whose native language is neither Chinese nor English, to develop their multilingual reading and writing skills in their native, English and Chinese languages.
6) The invention provides a scalable solution for millions of children who have no opportunity going to school, or who were ‘left-behind” without adults' supervision. This invention provides an unprecedented method allowing children to learn by teaching themselves.

While the invention has been herein shown and described in what is presently conceived to be the most practical and preferred embodiment thereof, it will be apparent to those of ordinary skill in the art that many modifications may be made thereof which scope is to be accorded the broadest interpretation of the appended claims so as to encompass all equivalent methods and processes.

Although the present invention has been described in terms of the presently preferred embodiments, various modifications and alterations can be made without departing from the scope of the invention. Accordingly, the scope of the invention is not to be limited to the particular invention embodiments discussed herein, but should be defined only by the appended claims and their equivalents.

1. A method and system for children learning a language, said method comprising the steps:
look at a picture representing a concept;
look at a word, in one form of the language, relating to the picture;
look at the 2^{nd} word, in the same form of the language, relating to the 1^{st} word;
optionally, look at a picture representing a concept relating to the 2^{nd} word;
listen to audios of the 1^{st} word, the 2^{nd} word, and text depicting the relation between the 1^{st} and the 2^{nd} word.

2. A method and system of claim 1, further comprising the step to look at the 2^{nd} picture prior to looking at the 2^{nd} word.

3. A method and system of claim 1, further comprising the step to listen to audios of the 1^{st}, 2^{nd} word and text, while looking at the 1^{st}, 2^{nd} word, text depicting the relation between the 1^{st} and the 2^{nd} word.

4. A method and system of claim 1, further comprising the step to look at the 2^{nd} word in a different form, or look at a same or a different 2^{nd} word with same or different relation to the 1^{st} word, while listening to audios with highlighted picture, word, and text of relation respectively.

5. A method and system of claim 1 further comprising the step to highlight the picture, 1^{st} and 2^{nd} word; text of relations between words; text depicting notion or knowledge with the 1^{st}, 2^{nd} word, relation and other information, while listening to audios of each element respectively.

6. A method and system of claim 1, further comprising to look at one or a plurality of pictures, or motion pictures representing concepts, thoughts; to look at one or a plurality of words, and texts depicting one or a plurality of relations between words; to look at texts depicting notions, knowledges, dialogues and other information, while listening to audios of each element respectively.

7. A method and system for children learning the reading and writing of a language, said method comprising the steps of:
look at a picture representing a concept;
read the word displayed in one form of a language, relating to the picture, and listen to the audio of the word;
look at the handwriting form of the word, read the word and listen to the audio of the word;
look at a picture depicting the strokes of the word in the hand-writing form;
move the pointing device or finger following one or more strokes to write the word, and listening to the audio of the word.

8. A method and system of claim 7, further comprising to read the character, word in one or more printing forms of a language; to look at one or more handwriting forms of the character and word; to look at a picture depicting one or more strokes that connect one or more characters of the word in a hand-writing form; to write the character and the word by moving a pointing device or finger following one or more strokes and listening to the audio of the character and word.

9. A method and system of claim 7, further comprising to look at one or a plurality of pictures, or motion pictures representing concepts, thoughts; to read one or a plurality of words in one or more printing forms of a language; to look at one or more handwriting forms of the character and word; to look at one or more strokes that connect one or more characters of the word in a hand-writing form; to write one or a plurality of words by moving a pointing device or finger following one or more strokes in their proper sequences; and to listen to audios of one or a plurality of words, texts depicting relations, and texts depicting notions, knowledges or dialogues and other information.

10. A method and system for children learning the reading and writing of multiple languages, said method comprising the steps of:
look at a picture representing a concept in the 1^{st} language;
read the 1^{st} word in the 1^{st} language, relating to the concept depicted by the picture;
read the 1^{st} word in the 2^{nd} language as a translation of the 1^{st} word in the 1^{st} language;
optionally, look at a picture representing a concept relating to the 1^{st} word in the 2^{nd} language;
listen to audios of the 1^{st} word in both languages respectively;
repeating the above steps to look at a picture relating to the 2^{nd} word in the 1^{st} language, to read the 2^{nd} word in both languages; optionally, to look at a picture relating the 2^{nd} word in the 2^{nd} language; and
listening to audios of the 2^{nd} word in both languages respectively;
listen to audios of the 1^{st}, 2^{nd} word and text depicting the relations in the 1^{st} and 2^{nd} language respectively.

11. A method and system of claim 10, further comprising to look at one or a plurality of pictures representing concepts, thoughts; to read a plurality of words, synonyms, antonyms in the 1^{st} language; to read a plurality of words in the 2^{nd} language as alternative translations of the words in the 1^{st} language; and listening to audios while highlighting words and texts depicting the relations between words in the 1^{st} and 2^{nd} language respectively.

12. A method and system of claim 10, further comprising the step to look at one or a plurality of pictures representing concepts, thoughts in its respective language culture, or looking at the Chinese character picture as the 2^{nd} picture in the 2^{nd} alphabetical language; and listening to audios while highlighting pictures, words, text of relations, texts depicting notions, knowledges and other information in the 1^{st} and 2^{nd} language respectively.

13. A method and system of claim 10, further comprising the step to read one or a plurality of words, texts depicting one or a plurality of relations between words; to read a plurality of texts depicting one or a plurality of notions, knowledges or dialogues in one or a plurality of languages; to listen to audios while highlighting words, relations, texts depicting notions, knowledges, dialogues and other information, in one or a plurality of languages interchangeably.

14. A method and system of claim 1, further comprising to look at one or a plurality of pictures, or motion pictures, representing concepts, thoughts; to read one or a plurality of words, and texts depicting one or a plurality of relations between words; to write one or a plurality of words by moving a pointing device or finger following one or more strokes in their proper sequences; to read a plurality of texts depicting one or a plurality of notions, knowledges, dialogues and other information, while listening to audios of each element respectively.
